(19) United States
(12) Patent Application Publication
(10) Pub. No.: US 2005/0260300 A1
(43) Pub. Date: Nov. 24, 2005

(54) Method of the production of novel food material

(75) Inventors: Norio Tada, Kawasaki-shi (JP); Nobutoshi Matsumoto, Kawasaki-shi (JP); Michinari Sakurai, Kawasaki-shi (JP); Yasushi Nishimura, Kawasaki-shi (JP); Kyoko Koibuchi, Kawasaki-shi (JP); Hideki Okamura, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 11/087,511

(22) Filed: Mar. 24, 2005

(30) Foreign Application Priority Data
Mar. 25, 2004 (JP) 2004-088684

(51) Int. Cl. A23L 1/20

(52) U.S. Cl. 426/52

(57) ABSTRACT

The present invention relates to a fermented soybean paste-like foodstuff, which exhibits thickness, strong umami taste and richness and which does not contain sodium chloride and a method of producing the same. The present invention also relates to a food material or a seasoning containing a fermented soybean paste-like foodstuff produced by the method proffered by the present invention.

### CROSS-REFERENCE TO RELATED APPLICATIONS

The present application claims priority to Japanese Application No. JP 2004-088684 filed on Mar. 25, 2004, which is hereby incorporated by reference in its entirety.

### BACKGROUND OF THE INVENTION

1. Field of the Invention

The present invention provides a method for the production of a fermented soybean paste-like foodstuff, which exhibits thickness, strong umami taste and richness and which does not contain sodium chloride. The present invention also relates to a food material or a seasoning containing a fermented soybean paste-like foodstuff produced by the method proffered by the present invention.

2. Discussion of the Background

Fermented soybean paste (miso) is a Japanese traditional food which may be referred to as roots of fermented foods. However, due to shifting Western life-style in recent years, dishes prepared using the fermented soybean paste, especially soups of fermented soybean paste (miso soup); have been on a downward trend. Thus, in order to boost the demand for fermented soybean paste as a healthy diet, development of foods using fermented soybean paste, fitting with the demands current society and their lifestyle are desired. However, fermented soybean paste contains a significant amount of salt and, thus, there is a strong concern that heavy use of fermented soybean paste may cause excessive salt consumption. Accordingly, in the present circumstances, demand for fermented soybean paste has decreased.

Nonetheless, fermented soybean paste has been conventionally used in dressings, a variety of seasoning or the like in addition to miso soups. As described above, when the fermented soybean paste is intended for various applications, concerns exist in addition to the salinity, including the presence of various microorganisms that intrinsically exist in the fermented soybean paste, particularly, bacteria belonging to genera Bacillus that are heat resistant bacteria, which often lead to problems. More specifically, because the fermented soybean paste is usually fermented while being exposed to the outside air during its production, it may become contaminated with a variety of microorganisms. However, due to the sodium chloride content, these microorganisms usually do not proliferate; however, when the fermented soybean paste is used in dressings and the like, the intrinsically existing microorganisms therein may proliferate in the product, and may cause deterioration of the product.

Accordingly, the present inventors investigated, and consequently succeeded (see below), in the development of an entirely new fermented soybean paste-like food material that does not contain sodium chloride and has reduced intrinsically existing microorganisms, particularly bacteria belonging to genera Bacillus to an undetectable level, on the basis of the method of the production of a fermented soybean paste. This food material does not contain sodium chloride, and no microorganism is detected therein. In addition, content of amino acids, particularly glutamic acid is higher in comparison with that in ordinary fermented soybean paste. Thus, this food material exhibits thickness, strong umami taste and richness, and is applicable for use in seasonings, as well as use as foodstuffs which may be eaten without further processing.

Conventionally, in an attempt to provide a method for production of a reduced-salt fermented soybean paste or a salt-free fermented soybean paste, a variety of methods have been proposed, including: a production method for a food highly containing protein by using low-salt fermented soybean paste produced by diluting and dialyzing a fermented soybean paste (JP-A No. S58-175463), a production method for a desalted fermented soybean paste by dilution of a fermented soybean paste with water (JP-A No. S63-214154), etc.

Further, a method in which a salt-free fermented soybean paste is prepared on a laboratory scale by performing lactic acid fermentation by inoculating a lactic acid bacterium that produces bacteriocin referred to as nisin is disclosed (Handbook of applied unheated sterilization of foods, Takeo Katou, p. 216), in which a member of the genera Bacillus and other contaminating bacteria are reportedly not detected. However, upon production of the fermented soybean paste on an industrial scale in practice, merely adding the nisin producing lactic acid bacterium causes rancidity through remarkable proliferation of various microorganisms introduced from the outside air, particularly lactic acid bacteria such as genera Pediococcus and Enterococcus. Accordingly, the pH was lowered due to lactic acid produced by those lactic acid bacteria. In other words, although preparation of the salt-free fermented soybean paste on a laboratory scale is comparatively easy in terms of control of the microorganisms, control of undesired microorganisms is very difficult upon manufacture in an industrial scale.

The handbook of applied unheated sterilization of foods, Takeo Katou, describes that industrial production of the salt-free fermented soybean paste is currently under study, however, specific conditions for the manufacture is not disclosed. Thus, an essential element constituting the present invention, i.e., koji making carried out in a state where the outside air is shut out is not referred to at all.

Further, a production method for koji in which processing a raw material for koji comprising water spraying, steaming, cooling, and koji making is performed in a single apparatus using a rotary drum steamer is disclosed (JP-A No. H07-107966). In this method, no undesired microorganism was reportedly detected in the resulting koji. However, JP-A No. H07-107966 relates to a method and an apparatus for the culture of koji, and hydrolysis of the unrefined soy in the absence of sodium chloride, i.e., production of the salt-free fermented soybean paste is not referred to at all. Furthermore, the apparatus described in JP-A No. H07-107966 is complicated and expensive due to a combined pipe for water and steam supply, a driving device for rotating the vessel and the like.

Accordingly, development of a production method for a food material which is fermented under a salt-free condition without contamination of microorganisms, using an inexpensive apparatus having a simple structure is in high demand.

### SUMMARY OF THE INVENTION

It is an object of the present invention to provide a novel fermented soybean paste-like foodstuff in an industrial scale that exhibits sufficient thickness, strong umami taste and richness, which is salt-free and can be used as wide variety of processed foods, seasonings such as dipping sauces and sauces, and novel food materials.

The present inventors elaborately investigated in order to solve the problems existing in the art as described above, and consequently found that a novel fermented soybean paste-like foodstuff meeting the above-stated object can be produced by a method which comprises: adding a koji mold and a culture broth of a bacteriocin producing lactic acid bacterium or a supernatant thereof to a food material, making koji in a koji-making machine in which the outside air is excluded except for the time period of “TEIRE”-treatment, while supplying sterilized air continuously or intermittently, then mixing thus resulting koji with a culture broth of a bacteriocin producing lactic acid bacterium or a supernatant thereof, and further mixing with a food material or materials in an amount of 0.01 to 50 times by weight of the resulting koji as needed, then forming an unrefined soy by making the paste form of the mixture, and then hydrolyzing the unrefined soy essentially in the absence of sodium chloride.

Accordingly, the invention is as follows.

(1) A method for producing a fast fermented soybean paste-like foodstuff comprising:
adding a koji mold and a culture broth of a bacteriocin producing lactic acid bacterium, or a supernatant thereof, to a food material,
making koji in a koji-making machine in which the outside air is excluded, with the exception of a time period for “TEIRE”-treatment, while supplying sterilized air,
mixing the resulting koji with a culture broth of a bacteriocin producing lactic acid bacterium, or a supernatant thereof, to form a koji and culture broth mixture,
mixing the koji and culture broth mixture with a food material or materials in an amount of 0.01 to 50 times by weight of the resulting koji to form a koji, culture broth mixture, and food material mixture,
forming an unrefined soy by making the paste form of the koji, culture broth mixture, and food material mixture, and
hydrolyzing the unrefined soy substantially in the absence of sodium chloride.

(2) The method according to (1), wherein said food material is soybean, rice or wheat.

(3) The method according to (1), wherein said koji mold is A. sojae and/or A. oryzae.

(4) The method according to (1), wherein said bacteriocin producing lactic acid bacterium is a nisin producing lactic acid bacterium.

(5) The method according to (4), wherein the nisin activity of a culture broth of the nisin producing lactic acid bacterium or a supernatant thereof is 20 IU/ml or higher.

(6) The method according to (4), wherein the nisin activity of a culture broth of the nisin producing lactic acid bacterium or a supernatant thereof is 200 IU/ml or higher.

(7) The method according to (1), wherein said lactic acid bacterium is Lactococcus lactis AJ110212 (FERM BP-8552).

(8) The method according to (1), wherein said sterilized air is sterilized with a filter which can collect 99.97% or more of dust of 0.3 μm or larger.

(9) The method according to (1), wherein the time period of koji making is 17 to 62 hours, and the time period of koji making in which the outside air is shut out is 15.5 to 61.5 hours.

(10) The method according to (1), wherein the amount of the said culture broth of a bacteriocin producing lactic acid bacterium or a supernatant thereof added to the food material is 0.0001 to 0.2 time in weight of the food material.

(11) The method according to (1), wherein the amount of the said culture broth of a bacteriocin producing lactic acid bacterium or a supernatant thereof added to the food material is 0.001 to 0.1 time in weight of the food material.

(12) The method according to (1), wherein the amount of the said culture broth of a bacteriocin producing lactic acid bacterium or a supernatant thereof mixed with the resulting koji is 0.01 to 5 times in weight of the resulting koji.

(13) The method according to (1), wherein said hydrolyzing is at a temperature ranging from 20 to 50° C. for 1 to 50 days.

(14) The method according to (1), wherein the hydrolyzing is at a temperature ranging from 20 to 45° C. for 3 to 30 days.

(15) The method according to (1), wherein said “TEIRE”-treatment is for a time of less than 1.5 hours (preferably less than 30 minutes) and at a frequency of once every 5-15 hours (preferably every 10 hours) during koji making.

(16) A fermented soybean paste-like foodstuff exhibiting thickness, strong umami taste and richness, which can be used as a food material or as a seasoning and be obtained by the production method according to any one of (1) to (15).

The above objects highlight certain aspects of the invention. Additional objects, aspects and embodiments of the invention are found in the following detailed description of the invention.

### DETAILED DESCRIPTION OF THE INVENTION

Unless specifically defined, all technical and scientific terms used herein have the same meaning as commonly understood by a skilled artisan in enzymology, biochemistry, cellular biology, molecular biology, and the food sciences.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

Advantages of the present invention include: providing a novel fermented soybean paste-like foodstuff having a perceptional image of healthiness on behalf of being salt-free; containing higher glutamic acid content and soluble nitrogen at shorter period of fermentation and aging process compared to an ordinary fermented soybean paste, because of the absence of inhibition by sodium chloride of the activities of enzymes in koji mold such as protease and peptidase; exhibiting thickness; having a strong umami taste; having a desired richness; and being suitable for use in seasoning applications as well as use as a food material. Of equal significance is that the present invention may be practices by using a simple and inexpensive manufacturing apparatus.

The food material used for koji in the present invention may be soybean, rice, wheat or the like which has been used in usual fermented soybean paste. Such raw materials may be soaked in water and/or steamed as needed.

A culture broth of a lactic acid bacterium having an ability to produce bacteriocin (an anti-bacterial substance) or a supernatant thereof and koji mold are to be mixed with the aforementioned raw material. The mixture is put into a koji making machine that may be supplied with sterilized air and which can maintain the inner part of the machine free from outside air. The koji making machine meeting these requirements should also be able to supply sterilized air into the koji making machine, and have a structure allowing the inner part of the koji making machine to exclude ambient air. For example, a koji making machine of the rotary drum type can be used. However, a koji making machine having a structure allowing sterilized air to be supplied into the koji making machine, being equipped with an openable and closable cover capable of keeping the inner part out of the outside air is more preferred because the structure is simple and the apparatus is inexpensive.

For sterilizing the air, a filter which can collect 99.97% or more of dust of 0.3 μm or larger, e.g., HEPA filter or the like may be used. The outlets for air of the koji making machine must be fitted with a filter for shutting out the outside air. Koji making machines which cannot maintain the inner part thereof free from the introduction of outside air, include rotary disc type koji making machines, static ventilation type koji making machines and the like, and thus are subject to contamination with microorganisms from the outside air. These microorganisms include lactic acid bacteria such as genera Pediococcus and Enterocuccus which produce lactic acid during aging and may cause so-called rancidity. The ventilation system is not particularly limited, but a ventilation system in which the air supplied from the bottom of the machine, a ventilation system in which the air supplied from the upper part of the machine or the like may be used.

The culture broth of a lactic acid bacterium or a supernatant thereof preferably has, for example, the nisin activity of 20 IU/ml or higher and preferably 200 IU/ml or higher which may be added in an amount of 0.0001 to 0.2 times, preferably 0.001 to 0.1 times, and more preferably 0.01 to 0.05 times of the raw material for koji. When the amount is less than 0.0001 times, an anti-bacterial activity is insufficient to prevent from contamination with undesirable microorganisms. Needless to say, the amount of the culture broth of the lactic acid bacteria or the supernatant thereof may be adjusted by the nisin activity. When the amount is greater than 0.2 times, moisture content of the raw material becomes so high that the growth of the Koji mold is adversely affected.

In addition to nisin, examples of the bacteriocin produced by lactic acid bacteria include pediocin, sakacin, nukacin and the like. Among them, nisin is preferably used due to its wide antibacterial spectrum. When the bacteriocin is nisin, the kind thereof which is produced by lactic acid bacteria may be any one of nisin A, nisin Z and analogues thereof. Higher bacteriocin activity in the culture broth of the lactic acid bacterium or a supernatant thereof for use is desired for preventing contamination with and proliferation of microorganisms. Thus, for example, L. lactis AJ110212 (FERM BP-8552) and the like which produce significant amounts of nisin Z may be used. The L. lactis AJ110212 strain was deposited on Nov. 19, 2003 with National Institute of Advanced Industrial Science and Technology, Patent Microorganisms Depositary Center under the accession number of FERM BP-8552.

As the Koji mold, A. oryase and/or A. sojae may be used in fermented soybean pastes. It is desired that the Koji mold for use can efficiently hydrolyze the raw material protein into amino acids and peptides, and can impart thickness, strong umami taste and richness to the resultant novel fermented soybean paste-like foodstuff, but not particularly limited thereto.

After putting the mixture of the raw material for koji, the culture broth of a lactic acid bacterium or a supernatant thereof and Koji mold into the koji making machine, koji making is performed at a temperature ranging from 20 to 40° C., preferably 24 to 34° C., for 17 to 62 hours, preferably for 43 to 55 hours, and more preferably for 43 to 49 hours. To this end, the inner part of the koji making machine is maintained as being free from outside air with the exception of the time period of “TEIRE”-treatment (a step of stirring the mixture in the koji making machine, for example, every 10 hours for the purpose of accelerating the growth of the Koji mold) to obtain koji.

When the temperature of koji making is 40° C. or higher, enzymatic activity required for hydrolysis of the material protein is reduced, while the temperature of 20° C. or lower results in insufficient growth of the Koji mold. In either case, the enzyme required for hydrolysis of the raw material protein can not be sufficiently obtained, therefore, a novel fermented soybean paste-like foodstuff exhibiting satisfactory thickness, umami taste and richness can not be obtained.

Further, when the time period of koji making is less than 17 hours, the Koji mold does not grow enough, therefore, a novel fermented soybean paste-like foodstuff exhibiting satisfactory thickness, umami taste and richness can not be obtained. When the time period of koji making needs to be shorter, it is desirable to set the temperature for koji making to 34 to 40° C. in order to accelerate the growth speed of the koji mold. Moreover, when the time period for koji making is longer than 62 hours, the enzymatic activity required for hydrolysis of the raw material protein becomes so low that satisfactory thickness, umami taste and richness can not be obtained, but bitterness may be imparted. When the time period of koji making needs to be longer, it is desirable to set the temperature for koji making to 20 to 30° C. in order to suppress the growth speed of the koji mold.

Because the inner part of the koji making machine is exposed to the outside air upon “TEIRE”-treatment, there is a risk of contamination with undesired microorganisms. Therefore, to minimize the risk, total time period of the “TEIRE”-treatment, in other words lo the integrated value of the time period during which the inner part of the koji making machine is exposed to the outside air, must be as short as possible. Specifically, it is necessary to reduce the time for “TEIRE”-treatment or to reduce the number of such treatments. The time for one “TEIRE”-treatment should be less than 1.5 hours, preferably less than 30 minutes and more preferably around 15 minutes. However, it is also possible to use “TEIRE” for about 2 minutes. The usual frequency of “TEIRE”-treatment is once every 10 hours during the koji making process. However, it is also within the scope of the present invention that the frequency of “TEIRE”-treatment is once every 5-15 hours during the koji making process. Accordingly, the koji making is carried out in the state where the outside air is excluded for at least 15.5 to 61.5 hours, and preferably 16.5 to 60.5 hours.

Next, to the resulting koji a culture broth of a lactic acid bacterium that produces bacteriocin such as nisin, or a supernatant thereof, is added such that the moisture content of the unrefined soy becomes 35 to 60%, and preferably 40 to 50%. The amount of the culture broth to be added ranges from 0.01 to 5 times, preferably 0.1 to 1 time of the weight of koji, and as needed, thereto is added a food material or materials in an amount of 0.01 to 50 times of the weight of koji to obtain an unrefined soy.

In this regard, the term “as needed” means that there is a case where an addition of soybean at the process for preparing an unrefined soy may not be required when soybean is used as the raw material of koji. More specifically, when soybean is used as a material of koji, a culture broth of a lactic acid bacterium or a supernatant thereof, is again added to the resulting koji made of the mixture of soybean, a culture broth of a lactic acid bacterium or a supernatant thereof and Koji mold, whereby forming the unrefined soy.

Moreover, a food material such as soybean, rice, or the like may be added to the resulting koji. In this case, the food material may be previously steam-cooked or roasted. For example, when rice koji prepared from rice as a koji material or wheat koji from wheat is used, previously steam cooked or roasted soybean may be added to the resulting koji. When soybean koji is used, previously steam-cooked or roasted wheat or rice may be added to the resulting koji and soybean also may be added for the production cost reduction purpose. Further, an extract from the said plant materials or a spesicfic componebt thereof may be added to the resulting koji. The examples include soybean extract, rice starch, wheat bran and the like. The taste or flavor as well as color of the fermented soybean paste-like foodstuff can be controlled by the kind or the amount of the food material added to the resulting koji. For example, sweetness can be imparted by adding rice. The order of adding the culture broth or the supernatant and the food material is not limited. The food material may be added to the resulting koji before or after the culture broth or the supernatant is added, or together with the culture broth or the supernatant.

When the amount of the culture broth of a lactic acid bacterium, or a supernatant thereof, that is added is less than 0.01 times, proliferation of the microorganisms can not be suppressed. Further, when it is greater than 5 times, insufficient hydrolysis of the protein may be achieved, thereby failing to provide a novel fermented soybean paste-like foodstuff exhibiting enough thickness, umami taste and richness.

The mixture of the resulting koji, a food material or materials, and the culture broth of a nisin lactic acid bacterium or the supernatant thereof is ground with a chopper or the like, and thus a paste form is obtained to form an unrefined soy. The unrefined soy is incubated at 20 to 50° C., preferably 20 to 45° C., and more preferably 25 to 35° C. for fermentation (aging) and hydrolyzed for 1 to 50 days, preferably 3 to 30 days, more preferably 4 to 14 days, and further preferably 4 to 9 days. When the temperature is lower than 20° C., hydrolysis of the protein is not sufficient, and thus, a novel fermented soybean paste-like foodstuff exhibiting sufficient thickness, umami taste and richness can not be obtained. Also, a temperature of greater than 50° C. is not preferred because sugars and amino acids in the unrefined soy react to impart browning odors, burnt odors and bitterness to the novel fermented soybean paste-like foodstuff. Similar tendencies are also found for the number of days of aging. Aging for less than 24 hours may result in insufficient hydrolysis of the protein, and thus, a novel fermented soybean paste-like foodstuff exhibiting sufficient thickness, umami taste and richness can not be obtain. While, aging for longer than 50 days is not preferred because sugars and amino acids in the unrefined soy react to imparts browning odors, burnt odors and bitterness to the novel fermented soybean paste-like foodstuff.

After completing aging and hydrolysis the unrefined soy is heated at 50 to 130° C. for 1 to 150 minutes. The purposes of this heating are sterilization and prevention of quality deterioration during the storage period by deactivating the enzyme such as protease in the unrefined soy. Processes for heating is not limited, but a double pipe heater, a multiple pipe heater or the like which has been used in pasteurization of fermented soybean pastes can be used. Also, a warm water bath or the like may be used. A heating temperature of lower than 50° C. may result in insufficient sterilization and inactivation of the enzyme, while a temperature greater than 130° C. is not preferred due to causing browning odors, burnt odors and bitterness. A similar tendency is found for the time period. Thus, the heating time period of less than 1 minute may result in insufficient sterilization and inactivation of the enzyme, while that of longer than 150 minutes is not preferred due to causing browning odors, burnt odors and bitterness.

Although this novel fermented soybean paste-like foodstuff can be used in a paste form without additional processing, it may be also used in the form of powder after drying by a spray drier, drum drier, a vacuum drum drier, a freeze drier or the like.

The novel fermented soybean paste-like foodstuff obtained according to the method of the invention exhibits thickness, strong umami taste and richness based on the sensory evaluation. This novel fermented soybean paste-like foodstuff is versatile which can be extensively utilized in various types of foods and beverages. The foodstuff is characterized by an effect to improve qualities of tastes of foods and beverages through imparting richness and thickness thereto. For example, it can be used in sauces for Western dishes such as demiglace sauce, western soups such as potage, seasonings for Chinese dishes such as Tobanjan (fermented broad bean paste with red pepper), seasonings for Japanese dishes such as dipping sauces. In addition, it can be also used in confectioneries such as bean-jam, pudding, ice cream, cake and the like which have been inconceivable for conventional fermented soybean paste. Moreover, it is delicious enough even if it is eaten as it is. Just slight adjustment of the taste enables ingestion of health functions included in soybean in large quantities.

The mode of use of the novel fermented soybean paste-like foodstuff obtained according to the method of the invention may be any one of: modes in which it is used upon production or processing of various foods and beverages; methods of use through blending it in various liquid, granulated or powder seasonings; modes in which it is eaten as it is and the like.

The above written description of the invention provides a manner and process of making and using it such that any person skilled in this art is enabled to make and use the same, this enablement being provided in particular for the subject matter of the appended claims, which make up a part of the original description.

As used herein, the phrases “selected from the group consisting of,” “chosen from,” and the like include mixtures of the specified materials.

Where a numerical limit or range is stated herein, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Having generally described this invention, a further understanding can be obtained by reference to certain specific examples, which are provided herein for purposes of illustration only, and are not intended to be limiting unless otherwise specified.

### EXAMPLES

### Example 1

### Study on Aging Time

50 kg of soybean was soaked in water to facilitate water absorption, and then was steam-cooked in a steam cooker at 114° C. for 40 minutes. The steam-cooked soybean was placed into an airtight koji-making machine (i.e., a machine in which outside air is prevented from reaching the inner part) and mixed with 1 kg of a culture broth of L. lactis (nisin activity: 1208 IU/ml) and 0.05 kg of a koji mold starter (“Koji mold starter for fermented soybean paste” manufactured by Bioc). Subsequently, koji making was effectuated at 30° C. for 43 hours in an airtight koji-making machine. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 15 minutes every 10 hours after the initiation of koji making and entails introduction of outside air into the inner part of the koji-making machine. Following koji making, 15.4 kg of a culture broth of L. lactis (nisin activity: 1208 IU/ml) was added to the resultant koji. Following mixing, the mixture was grinded with a chopper to give a paste form. The paste was packed in a laminated pouch to a content of 500 g per one pack. After incubating this pouch at 30° C. for 3 to 60 days, it was heated at 80° C. for 40 minutes.

Analyses of solubilized nitrogen (solubilized TN), glutamic acid concentration, lactic acid concentration, pH, and microorganisms were performed on the novel fermented soybean paste-like foodstuff obtained by the above-described method. In addition, sensory evaluation was conducted by using a sensory evaluation panel consisting of 3 experts. For the sensory evaluation, the sample was eaten as it was and scored by one to five points, with three points or more being evaluated as acceptable. The results are shown in Table 1.

TABLE 1

| | Aging period | | | | | | |
|---|---|---|---|---|---|---|---|
| | 3 days | 4 days | 7 days | 9 days | 14 days | 30 days | 60 days |
| TN (weight %) | 1.2 | 1.6 | 2.4 | 2.5 | 2.7 | 2.7 | 2.6 |
| GH (weight %) | 0.58 | 0.76 | 1.90 | 2.10 | 2.33 | 2.30 | 2.29 |
| Lactic acid | 0.98 | 1.02 | 1.23 | 1.30 | 1.48 | 1.42 | 1.40 |
| (weight %) | | | | | | | |
| pH | 5.8 | 5.4 | 5.4 | 5.4 | 5.3 | 5.3 | 5.4 |
| Microorganism | | | | | | | |
| examination | | | | | | | |
| Viable Bacterial | <10 cfu/g | <10 cfu/g | <10 cfu/g | <10 cfu/g | <10 cfu/g | <10 cfu/g | <10 cfu/g |
| Counts | | | | | | | |
| Heat Resistant | <10 cfu/g | <10 cfu/g | <10 cfu/g | <10 cfu/g | <10 cfu/g | <10 cfu/g | <10 cfu/g |
| bacteria | | | | | | | |
| Coliform | negative | negative | negative | negative | negative | negative | negative |
| Bacteria | | | | | | | |
| Sensory score | 3.5 | 4.5 | 5.0 | 4.5 | 4.0 | 3.5 | 2.5 |
| | Rather weak | | Strong | | Bitterness | Slightly | Strong |
| | umami taste | | umami taste | | felt | strong | Bitterness, |
| | | | and richness | | | bitterness | and |
| | | | | | | | unacceptable |
| | | | | | | | in sensory |
| | | | | | | | test |

Consequently, no microorganisms were detected in the experimental groups. Furthermore, the novel fermented soybean paste-like foodstuff which was evaluated as acceptable in the sensory test was those of 3 to 30 days; thickness, strong umami taste and richness were exhibited in those of 4 to 14 days; high scores were given for those of 4 to 9 days; and the best score was given to that of 7 days. Therefore, it was confirmed that the time period of aging and hydrolysis might be 3 to 30 days, preferably 4 to 14 days, and more preferably 4 to 9 days. Concentrations of solubilized TN and glutamic acid should be strikingly noted. Commercially available general fermented soybean paste made only from soybean (mame miso) contains approximately 1.2 weight % of solubilized TN and 0.6 weight % glutamic acid. Thus, in this novel fermented soybean paste-like foodstuff, particularly, in one prepared with the hydrolysis period of 7 days or longer, solubilized TN is included 2 times or more, while glutamic acid is included 3 times or more, which would contribute to imparting thickness, strong umami taste and richness.

### Example 2

### Study on Hydrolysis Temperature

50 kg of soybean was soaked in water to allow water absorption, and was then steam-cooked in a steam cooker at 114° C. for 40 minutes. The steam-cooked soybean was placed into an airtight koji-making machine, and was mixed with 1 kg of a culture broth of L. lactis AJ110212 (FERM BP-8552) (nisin activity: 4500 IU/ml) and 0.05 kg of a koji mold starter (“Koji mold starter for fermented soybean paste” manufactured by Bioc). Subsequently, the mixture was subjecting to koji making at 30° C. for 43 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 15 minutes every 10 hours after the initiation of koji making and entails introduction of outside air into the inner part of the koji-making machine. To the resulting koji was added 15.4 kg of a culture broth of L. lactis AJ110212 (FERM BP-8552) (nisin activity: 4500 IU/ml). After mixing, the mixture was ground with a chopper to form a paste form. This paste was packed in a laminated pouch at an amount of 500 g per one pack. After incubating this pouch at 20 to 50° C. for 7 days, it was heated at 80° C. for 40 minutes.

Sensory evaluation was conducted by using a sensory evaluation panel consisting of 3 experts. For the sensory evaluation, the sample was eaten as it was and scored by one to five points, with three points or more being evaluated as acceptable. The results are shown in Table 2.

TABLE 2

| Aging period | 20° C. | 25° C. | 30° C. | 35° C. | 40° C. | 45° C. | 50° C. |
|---|---|---|---|---|---|---|---|
| TN (weight %) | 2.2 | 2.8 | 2.9 | 2.8 | 3.1 | 3.2 | 3.1 |
| GH (weight %) | 0.96 | 1.01 | 1.17 | 1.10 | 1.34 | 1.39 | 1.36 |
| Microorganism | | | | | | | |
| examination | | | | | | | |
| Viable Bacterial | <10 cfu/g | <10 cfu/g | <10 cfu/g | <10 cfu/g | <10 cfu/g | <10 cfu/g | <10 cfu/g |
| Counts | | | | | | | |
| Heat Resistant | <10 cfu/g | <10 cfu/g | <10 cfu/g | <10 cfu/g | <10 cfu/g | <10 cfu/g | <10 cfu/g |
| bacteria | | | | | | | |
| Coliform | negative | negative | negative | negative | negative | negative | negative |
| Bacteria | | | | | | | |
| Sensory score | 3.5 | 4.5 | 5.0 | 4.5 | 4.0 | 3.5 | 3.0 |
| | Rather weak | | Strong umami | | Bitterness felt | Slightly strong | Rather strong |
| | umami taste | | taste and | | | bitterness | bitterness, lower |
| | | | richness | | | | limit of |
| | | | | | | | acceptance |

Consequently, the novel fermented soybean paste-like foodstuffs evaluated as acceptable in the sensory test were those of 20 to 50° C. The samples exhibiting thickness, strong umami taste and richness, while the score point of 3.5 or greater was given were those of 20 to 45° C. Therefore, it was confirmed that the temperature of aging is 20 to 50° C., and preferably 20 to 45° C.

### Example 3

### Study on the Amount of Addition of Raw Material and Steam-Cooked Soybean

300 g of rice in an amount was soaked in water to allow water absorption, and steam-cooked in a small steam-cooker at 100° C. for 30 minutes. The steam-cooked rice was mixed with 6 g of a culture broth of L. lactis AJ110212 (FERM BP-8552) (nisin activity: 4500 IU/ml) and 1 g of a koji mold starter (manufactured by Higuchi Moyashi K.K.). The mixture was put into a laboratory koji-making machine, which can maintain its inner part free from outside air and subjected to koji making at 30° C. for 43 hours.

While koji was made in the koji-making machine while maintaining the inner part of the machine free from outside air except for the time period of “TEIRE”-treatment. The “TEIRE” treatment was performed for 2 minutes every 10 hours after the initiation of koji making and entails introduction of outside air into the inner part of the koji-making machine. Air sterilized by passing through a HEPA filter was used to remove the heat generated upon fermentation during the koji making. To 100 g of thus resulting rice koji was added soybean in an amount of 100 g, 250 g, 500 g, 1 kg, 2 kg, respectively, and then a culture broth of L. lactis AJ110212 (FERM BP-8552) (nisin activity: 4500 IU/ml) was mixed therewith in an amount of 0.15 g, 0.06 g, 0.015 g, 0.0075 g, sequentially such that the moisture content of the unrefined soy became 47%. Thereafter, the mixture was ground with a chopper to give a paste form. Thus resulting paste was packed in a laminated pouch such that 500 g is filled in one pack. After incubating this pouch at 30° C. for 7 days, it was heated at 80° C. for 40 minutes.

For the novel fermented soybean paste-like foodstuff obtained according to the above operation a sensory evaluation by the sensory evaluation panel consisting of 3 experts was carried out. Upon the sensory evaluation, the sample was eaten as it was and scored by one to five points, with three points or more being evaluated as acceptable. The results are shown in Table 3.

TABLE 3

| | Amount to koji(*) | | | | |
|---|---|---|---|---|---|
| | 1 | 2.5 | 5 | 10 | 20 |
| TN (weight %) | 0.8 | 1.3 | 1.9 | 2.2 | 2.5 |
| GH (weight %) | 0.53 | 0.90 | 1.30 | 1.76 | 1.88 |
| Microorganism examination | | | | | |
| Viable Bacterial Counts | <10 cfu/g | <10 cfu/g | <10 cfu/g | <10 cfu/g | <10 cfu/g |
| Heat Resistant bacteria | <10 cfu/g | <10 cfu/g | <10 cfu/g | <10 cfu/g | <10 cfu/g |
| Coliform Bacteria | negative | negative | negative | negative | negative |
| Sensory score | 5.0 | 5.0 | 5.0 | 5.0 | 5.0 |
| | Strong sweetness | Well-balanced | Rather strong | Rather strong | Rather strong |
| | | sweetness and | umami taste and | umami taste and | umami taste and |
| | | umami taste | richness | richness | richness |

*Amount of addition of steam-cooked soybean per I of rice koji

Consequently, each of the samples above that contained the novel fermented soybean paste-like foodstuff had acceptable sensory test scores. When the amount of the steam-cooked soybean added is small, the resultant foodstuff had a strong sweetness while showing a lighter color. To the contrary, when the amount of the steam-cooked soybean added to the resultant foodstuff is large, thickness, strong umami taste and richness were exhibited, as well as a darker red brown color.

### Example 4

### Study on the Amount of Charging Nisin Lactic Acid Bacterium

300 g of soybean was soaked in water to allow water absorption, and was then steam-cooked in a steam cooker at 114° C. for 40 minutes. The steam-cooked soybean was placed into an airtight koji-making machine, and was mixed with 0.3 to 30 g of a culture broth of L. lactis AJ110212 (FERM BP-8552) (nisin activity: 4500 IU/ml) and 1 g of a koji mold starter (“Koji mold starter for fermented soybean paste” manufactured by Bioc). Subsequently, the mixture was subjecting to koji making at 30° C. for 43 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 2 minutes every 10 hours after the initiation of koji making and entails introduction of outside air into the inner part of the koji-making machine. To the resulting koji was added 92.5 g a culture broth of L. lactis AJ110212 (FERM BP-8552) (nisin activity: 4500 IU/ml). After mixing, the mixture was ground with a chopper to form a paste form. This paste was packed in a laminated pouch at an amount of 300 g per one pack. After incubating this pouch at 30° C. for 7 days, it was heated at 80° C. for 40 minutes.

Sensory evaluation was conducted by using a sensory evaluation panel consisting of 3 experts. For the sensory evaluation, the sample was eaten as it was and scored by one to five points, with three points or more being evaluated as acceptable. The results are shown in Table 4.

TABLE 4

| | Amount of addition of | | |
|---|---|---|---|
| | nisin lactic acid bacterium (*) | | |
| | 0.001 times | 0.01 times | 0.1 times |
| TN (weight %) | 2.8 | 2.8 | 2.9 |
| GH (weight %) | 2.05 | 2.09 | 2.19 |
| Microorganism | | | |
| examination | | | |
| Viable Bacterial | <10 cfu/g | <10 cfu/g | <10 cfu/g |
| Counts | | | |
| Heat Resistant bacteria | <10 cfu/g | <10 cfu/g | <10 cfu/g |
| Coliform Bacteria | negative | negative | negative |
| Sensory score | 5.0 | 5.0 | 5.0 |
| | Strong umami | Strong umami | Strong umami |
| | taste and | taste and | taste and |
| | richness | richness | richness |

*Amount of addition to raw material

Contamination with undesired microorganisms was not observed when the amount of added nisin lactic acid bacterium falls within the range of 0.001 to 0.1 times the amount of koji. Accordingly, a novel fermented soybean paste-like foodstuff which is microbiologically clean was obtained.

### Example 5

### Study on the Nisin Activity in the Culture Broth of Lactic Acid Bacterium

350 g of soybean was soaked in water to allow water absorption, and was then steam-cooked in a steam cooker at 114° C. for 40 minutes. The steam-cooked soybean was placed into an airtight koji-making machine, and was mixed with 70 g of a culture broth of L. lactis AJ110212 (FERM BP-8552) (nisin activity: 26 to 2600 IU/ml) and 3.5 g of a koji mold starter (“Koji mold starter for fermented soybean paste” manufactured by Bioc). Subsequently, the mixture was subjecting to koji making at 30° C. for 43 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 2 minutes every 10 hours after the initiation of koji making and entails introduction of outside air into the inner part of the koji-making machine. To 275 g of the resulting koji was added 50 g a culture broth of L. lactis AJ110212 (FERM BP-8552) (nisin activity: 26 to 2600 IU/ml) and 175 g of steam-cooked rice. After mixing, the mixture was ground with a chopper to form a paste form. This paste was packed in a laminated pouch at an amount of 500 g per one pack. After incubating this pouch at 30° C. for 7 days, it was heated at 80° C. for 40 minutes.

Sensory evaluation was conducted by using a sensory evaluation panel consisting of 3 experts. For the sensory evaluation, the sample was eaten as it was and scored by one to five points, with three points or more being evaluated as acceptable. In addition, microbial analysis was performed. The results are shown in Table 5.

TABLE 5

| | Nisin Activity (*) | | |
|---|---|---|---|
| | 26 IU/ml | 260 IU/ml | 2600 IU/ml |
| TN (weight %) | 1.8 | 1.8 | 1.9 |
| GH (weight %) | 1.28 | 1.39 | 1.46 |
| Microorganism | | | |
| examination | | | |
| Viable Bacterial | <10 cfu/g | <10 cfu/g | <10 cfu/g |
| Counts | | | |
| Heat Resistant bacteria | <10 cfu/g | <10 cfu/g | <10 cfu/g |
| Coliform Bacteria | negative | negative | negative |
| Sensory score | 5.0 | 5.0 | 5.0 |
| | Strong umami | Strong umami | Strong umami |
| | taste and | taste and | taste and |
| | richness, well- | richness, well- | richness, well- |
| | balanced | balanced | balanced |
| | sweetness | sweetness | sweetness |

*Nisin activity in the culture broth of the lactic acid bacteria

Contamination with undesired microorganisms was not observed when amount of nisin activity of the culture broth of lactic acid bacterium was within the range of 26 to 2600 IU/ml. Accordingly, a novel fermented soybean paste-like foodstuff having good organoleptic quality and microbiologically clean was obtained.

### Example 6

### Study on the Condition of Koji-Making

300 g of soybean was soaked in water to allow water absorption, and was then steam-cooked in a steam cooker at 114° C. for 40 minutes. The steam-cooked soybean was placed into an airtight koji-making machine, and was mixed with 6 g of a culture broth of L. lactis AJ110212 (FERM BP-8552) (nisin activity: 3000 IU/ml) and 1 to 3 g of a koji mold starter (“Koji mold starter for fermented soybean paste” manufactured by Bioc). Subsequently, the mixture was subjecting to koji making at 30° C. to 35° C. for 16 to 62 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 2 minutes every 10 hours after the initiation of koji making and entails introduction of outside air into the inner part of the koji-making machine. To the resulting koji was added 92.5 g a culture broth of L. lactis AJ110212 (FERM BP-8552) (nisin activity: 2500 IU/ml). After mixing, the mixture was ground with a chopper to form a paste form. This paste was packed in a laminated pouch at an amount of 300 g per one pack. After incubating this pouch at 30° C. for 7 to 14 days, it was heated at 80° C. for 40 minutes.

Sensory evaluation was conducted by using a sensory evaluation panel consisting of 3 experts. For the sensory evaluation, the sample was eaten as it was and scored by one to five points, with three points or more being evaluated as acceptable. In addition, microbial analysis was performed. The results are shown in Table 6.

TABLE 6

| | | | | | |
|---|---|---|---|---|---|
| Koji making period (hr) | 16 | 19 | 22 | 43 | 62 |
| Koji making temp. (° C.) | 35 | 35 | 35 | 30 | 20 |
| Amount of koji mold | 3 | 3 | 3 | 1 | 1 |
| starter (g) | | | | | |
| Hydrolyzation period | 14 | 14 | 14 | 7 | 7 |
| (days) | | | | | |
| TN (weight %) | 1.08 | 1.83 | 2.17 | 2.7 | 2.54 |
| GH (weight %) | 0.32 | 0.58 | 1.03 | 2.07 | 1.97 |
| Microorganism | | | | | |
| examination | | | | | |
| Viable Bacterial Counts | <10 cfu/g | <10 cfu/g | <10 cfu/g | <10 cfu/g | <10 cfu/g |
| Heat Resistant bacteria | <10 cfu/g | <10 cfu/g | <10 cfu/g | <10 cfu/g | <10 cfu/g |
| Coliform Bacteria | negative | negative | negative | negative | negative |
| Sensory score | 2.5 | 4.0 | 4.0 | 5.0 | 4.0 |

### Example 7

### Effect of Adding Rice to the Resulting Koji

7000 g of soybean was soaked in water to allow water absorption, and was then steam-cooked in a steam cooker at 114° C. for 40 minutes. The steam-cooked soybean was placed into an airtight koji-making machine, and was mixed with 140 g of a culture broth of L. lactis AJ110212 (FERM BP-8552) (nisin activity: 2900 IU/ml) and 7 g of a koji mold starter (“Koji mold starter for fermented soybean paste” manufactured by Bioc). Subsequently, the mixture was subjecting to koji making at 30° C. for 43 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 15 minutes every 10 hours after the initiation of koji making and entails introduction of outside air into the inner part of the koji-making machine. Steam-cooked rice was prepared in a steam cooker at 114° C. for 40 minutes and cooled down to 30° C. To the resulting koji was added the steam-cooked rice in an amount adjusting the weight ratio of the resulting koji and the steam cooked rice to 9:1 to 5:5 (10:0 as the control) and the culture broth of L. lactis AJ110212 (FERM BP-8552) (nisin activity: 2200 IU/mi) in the amount adjusting the water content of the mixture to 43%. After mixing, the mixture was ground with a chopper to form a paste form. This paste was packed in a laminated pouch at an amount of 300 g per one pack. After incubating this pouch at 30° C. for 7 days, it was heated at 80° C. for 40 minutes.

Sensory evaluation was conducted by using a sensory evaluation panel consisting of 3 experts. For the sensory evaluation, the sample was eaten as it was and scored by one to five points, with three points or more being evaluated as acceptable. Each sample was evaluated for bitterness, umami taste and sweetness with the control (no rice was mixed, each sensory score was 5). In addition, microbial analysis was performed. The results are shown in Table 7.

TABLE 7

| | Ratio of koji and rice | | | | | |
|---|---|---|---|---|---|---|
| | 10:0 (control) | 9:1 | 8:2 | 7:3 | 6:4 | 5:5 |
| TN (weight %) | 2.6 | 2.3 | 2.1 | 1.7 | 1.1 | 1.1 |
| GH (weight %) | 2.0 | 1.7 | 1.5 | 1.3 | 0.7 | 0.6 |
| Direct sugars | 3.2 | 9.2 | 13.6 | 17.9 | 22.9 | 26.7 |
| (weight %) | | | | | | |
| Microorganism | | | | | | |
| examination | | | | | | |
| Viable Bacterial Counts | <10 cfu/g | <10 cfu/g | <10 cfu/g | <10 cfu/g | <10 cfu/g | <10 cfu/g |
| Heat Resistant bacteria | <10 cfu/g | <10 cfu/g | <10 cfu/g | <10 cfu/g | <10 cfu/g | <10 cfu/g |
| Coliform Bacteria | Negative | negative | negative | negative | negative | negative |
| Sensory evaluation | | | | | | |
| Bitterness | 5.0 | 4.3 | 3.7 | 3.0 | 2.5 | 2.0 |
| Umami taste | 5.0 | 4.6 | 4.3 | 3.5 | 3.2 | 3.2 |
| Sweetness | 5.0 | 5.3 | 6.0 | 7.0 | 7.5 | 7.7 |
| | strong umami | | | | | strong |
| | taste, richness | | | | | sweetness |
| | slight | | | | | |
| | bitterness | | | | | |

The bitterness was reduced and the sweetness was increased by adding rice to the resulting koji. The fermented soybean paste like foodstuff obtained by the addition of steam-cooked rice in a weight ratio between the resulting koji and the steam cooked rice of 9:1 to 5:5 had preferable umami taste, richness and sweetness. Accordingly, the fermented soybean-like foodstuff containing rice is suitable for a food in need of enhanced sweetness, but not bitterness.

### Example 8

50 kg of soybean was soaked in water to allow water absorption, and was then steam-cooked in a steam cooker at 114° C. for 40 minutes. The steam-cooked soybean was placed into an airtight koji-making machine, and was mixed with 1 kg of a culture broth of L. lactis AJ110212 (FERM BP-8552) (nisin activity: 4500 IU/ml) and 0.05 kg of a koji mold starter (“Koji mold starter for fermented soybean paste” manufactured by Bioc). Subsequently, the mixture was subjecting to koji making at 30° C. for 43 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 15 minutes every 10 hours after the initiation of koji making and entails introduction of outside air into the inner part of the koji-making machine. To the resulting koji was added 15.4 kg of a culture broth of L. lactis AJ110212 (FERM BP-8552) (nisin activity: 4500 IU/ml). After mixing, the mixture was ground with a chopper to form a paste form. This paste was packed in a laminated pouch at an amount of 500 g per one pack. After incubating this pouch at 30° C. for 7 days, it was heated at 80° C. for 40 minutes.

The fermented soybean paste-like foodstuff was used in the preparation of stir-fried vegetables. The stir-fried vegetables were prepared by adding 3.5 g of the novel fermented soybean paste-like foodstuff and 2.4 g of sodium chloride to 400 g of cabbage, 50 g of bean sprout and 150 g of pork followed by stirring-and frying. As a control, a similar dish was prepared by adding 20 g of commercially available fermented soybean paste (salt content: 11%) (amount of sodium chloride: 2.2 g) in place of the novel fermented soybean paste-like foodstuff followed by stirring-and frying. For the stir-fried vegetables, sensory evaluation was conducted by using a sensory evaluation panel consisting of 3 experts. The results are shown in Table 8.

TABLE 8

| | | Commercially available |
|---|---|---|
| | Novel fermented soybean | fermented soybean paste used |
| | paste-like foodstuff used | (Control) |
| Umami taste | ++ | + |
| Saltiness | − | + |
| Sourness | − | − |
| Sweetness | − | − |
| Bitterness | ± | − |
| Richness, | +++ | + |
| Thickness | | |
| Other | Richness, Excellent | Unclear taste |

When commercially available fermented soybean paste was used, the sharpness of taste was absent and richness was insufficient. On the other hand, when the novel fermented soybean paste-like foodstuff was used, richness was imparted to the stir-fried vegetables, which resulted in excellent sensory qualities.

### Example 9

50 kg of soybean was soaked in water to allow water absorption, and was then steam-cooked in a steam cooker at 114° C. for 40 minutes. The steam-cooked soybean was placed into an airtight koji-making machine, and was mixed with 1 kg of a culture broth of L. lactis AJ110212 (FERM BP-8552) (nisin activity: 4500 IU/ml) and 0.05 kg of a koji mold starter (“Koji mold starter for fermented soybean paste” manufactured by Bioc). Subsequently, the mixture was subjecting to koji making at 30° C. for 43 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 15 minutes every 10 hours after the initiation of koji making and entails introduction of outside air into the inner part of the koji-making machine. To the resulting koji was added 15.4 kg of a culture broth of L. lactis AJ110212 (FERM BP-8552) (nisin activity: 4500 IU/ml). After mixing, the mixture was ground with a chopper to form a paste form. This paste was packed in a laminated pouch at an amount of 500 g per one pack. After incubating this pouch at 30° C. for 7 days, it was heated at 80° C. for 40 minutes.

To 100 g of the fermented soybean paste-like foodstuff the following components were added: 2 g of sodium chloride, 1 g of vinegar and 5 ml of soy sauce. The resulting mixture was mixed well to make a paste product. As a control, a commercially available fermented soybean paste was used in place of the novel fermented soybean paste-like foodstuff and was mixed well with 2 g of sodium chloride, 1 g of vinegar and 5 ml of soy sauce, to make a paste product. For the paste product, sensory evaluation was conducted by using a sensory evaluation panel consisting of 3 experts. The results are shown in Table 9.

TABLE 9

| | | Commercially available |
|---|---|---|
| | Novel fermented soybean | fermented soybean paste |
| | paste-like foodstuff used | used(Control) |
| Umami taste | ++ | + |
| Saltiness | − | +++ |
| Sourness | − | − |
| Sweetness | + | − |
| Bitterness | ± | − |
| Richness, | +++ | + |
| thickness | | |
| Other | Rich, Excellent | Strong saltiness, Not |
| | | acceptable |

The paste product containing the commercially available fermented soybean paste resulted in strong saltiness, and also had weak thickness, umami taste and richness. On the other hand, the product containing the novel fermented soybean paste-like foodstuff exhibited richness and thickness. The novel fermented soybean paste-like foodstuff could be eaten as it is, and in addition, it could be also used as a dipping sauce.

### Example 10

50 kg of soybean was soaked in water to allow water absorption, and was then steam-cooked in a steam cooker at 114° C. for 40 minutes. The steam-cooked soybean was placed into an airtight koji-making machine, and was mixed with 1 kg of a culture broth of L. lactis AJ110212 (FERM BP-8552) (nisin activity: 4500 IU/ml) and 0.05 kg of a koji mold starter (“Koji mold starter for fermented soybean paste” manufactured by Bioc). Subsequently, the mixture was subjecting to koji making at 30° C. for 43 hours. Air sterilized by passing through a HEPA filter was used to remove the heat generated upon fermentation during the koji making.

While koji was made in the koji-making machine while maintaining the inner part of the machine free from outside air except for the time period of “TEIRE”-treatment. The “TEIRE” treatment was performed for 15 minutes every 10 hours after the initiation of koji making and entails introduction of outside air into the inner part of the koji-making machine. To the resulting koji was added 15.4 kg of a culture broth of L. lactis AJ110212 (FERM BP-8552) (nisin activity: 4500 IU/ml). After mixing, the mixture was ground with a chopper to form a paste form. This paste was packed in a laminated pouch at an amount of 500 g per one pack. After incubating this pouch at 30° C. for 7 days, it was heated at 80° C. for 40 minutes.

Custard cream was prepared by using the fermented soybean paste-like foodstuff. Six egg yolks, 150 g of sugar and 100 g of the novel fermented soybean paste-like foodstuff were thoroughly mixed, then thereto was added 50 g of wheat flour. After milk was heated to almost boiling, a 500 ml portion was added to the mixture. After mixing, thereto was added 500 g of melted butter to prepare a custard cream. As a control, a custard cream was prepared by adding 600 g of melted butter without adding the novel fermented soybean paste-like foodstuff. For this custard cream, sensory evaluation was conducted by using a sensory evaluation panel consisting of 3 experts. The results are shown in Table 10.

TABLE 10

| | Novel fermented soybean | |
|---|---|---|
| | paste-like foodstuff used | Not used |
| Umami taste | + | + |
| Saltiness | − | − |
| Sourness | − | − |
| Sweetness | +++ | − |
| Bitterness | ± | − |
| Richness, thick | +++ | + |
| texture | | |
| Other | Richness, Excellent | |

The custard cream to which the novel fermented soybean paste-like foodstuff was added exhibited richness and strong sweetness, which achieved excellent sensory results.

### Comparative Example 1

### Comparison Between an Open Type and an Airtight Type Koji Making Machine

500 kg of soybean was soaked in water to allow water absorption, and steam-cooked in a steam cooker at 114° C. for 40 minutes. To the steam-cooked soybean was added 10 kg of a culture broth of L. lactis AJ110212 (FERM BP-8552) (nisin activity: 4500 IU/ml) and 0.5 kg of a koji mold starter (“Koji mold starter for fermented soybean paste” manufactured by Bioc). The mixture was placed into a box type (open type; open to the outside air) koji making machine, and subjected to koji making at 30° C. for 43 hours. Unsterilized air was used for removal of the heat generated upon fermentation during the koji making. To the resulting koji was added 154 kg of a culture broth of L. lactis AJ110212 (FERM BP-8552) (nisin activity: 4500 IU/ml). After mixing, the mixture was ground with a chopper to form a paste form. This paste was packed in a laminated pouch at an amount of 500 g per one pack. After incubating this pouch at 30° C. for 7 days, it was heated at 80° C. for 40 minutes.

For the novel fermented soybean paste-like foodstuff obtained according to the above operation the following analyses were performed: analysis of microorganisms, analysis of solubilized TN, glutamic acid concentration, lactic acid concentration and pH, In addition, sensory evaluation was conducted by using a sensory evaluation panel consisting of 3 experts was conducted. For the sensory evaluation, the sample was eaten as it was and scored by one to five points, with three points or more being evaluated as acceptable. The results are shown in Table 11 together with the analyses results and evaluation results of the novel fermented soybean paste-like foodstuff obtained by the operation with completely identical conditions except that the airtight type koji making machine of the invention was used in place of the box type (open to the outside air) koji making machine.

TABLE 11

| | Open to the outside | |
|---|---|---|
| | air type koji | |
| | making machine | airtight type koji |
| | (static ventilation type) | making machine |
| TN (weight %) | 2.1 | 2.4 |
| GH (weight %) | 1.78 | 1.90 |
| Lactic acid (weight %) | 2.7 | 1.23 |
| PH | 4.71 | 5.4 |
| Microorganism examination | | |
| (before pasteurization) | | |
| Viable bacterial counts | 6.9 × 10⁸ cfu/g (*1) | 2.2 × 10² cfu/g |
| Heat resistant bacteria | 1.2 × 10⁶ cfu/g | <10 cfu/g |
| Coliform bacteria | negative | negative |
| microorganism examination | | |
| (after pasteurization) | | |
| Viable bacterial counts | 3.7 × 10³ cfu/g (*2) | <10 cfu/g |
| Heat resistant bacteria | 1.2 × 10³ cfu/g | <10 cfu/g |
| Coliform bacteria | negative | negative |
| Sensory score | 2.5 | 5.0 |
| | Strong sourness, Not | Strong deliciousness |
| | acceptable | and thick texture |

(*1) Almost all colonies were genera Pediococcus.
(*2) Almost all colonies were genera Bacillus.

As a result, the novel fermented soybean paste-like foodstuff prepared using the box type koji making machine was contaminated with undesired microorganisms such as genera Bacillus, Pediococcus and Staphyrococcus prior to pasteurization. Bacteria belonging to genera Bacillus remained also after the pasteurization. In addition, as a result of sensory evaluation, sourness was so strong that it was not acceptable. When the lactic acid value was measured, extremely high value was observed in comparison with the foodstuff prepared through koji making using the airtight type koji making machine. Accordingly, it was believed that rancidity was caused due to the contamination with genera Pediococcus.

In view of the foregoing, the present invention provides a novel fermented soybean paste-like foodstuff that can be used in seasoning applications or used as a foodstuff due to its thickness, strong umami taste and richness. As such, the novel fermented soybean paste-like foodstuff of the present invention can be used extensively in wide variety of seasonings such as dipping sauces, and in processed foods including confectioneries. Accordingly, the present invention is extremely advantageous in industry, particularly in a food industry.

Numerous modifications and variations on the present invention are possible in light of the above teachings. It is, therefore, to be understood that within the scope of the accompanying claims, the invention may be practiced otherwise than as specifically described herein.

1. A method for producing a fast fermented soybean paste-like foodstuff comprising:
adding a koji mold and a culture broth of a bacteriocin producing lactic acid bacterium, or a supernatant thereof, to a food material,
making koji in a koji-making machine in which the outside air is excluded, with the exception of a time period for “TEIRE”-treatment, while supplying sterilized air,
mixing the resulting koji with a culture broth of a bacteriocin producing lactic acid bacterium, or a supernatant thereof, to form a koji and culture broth mixture,
mixing the koji and culture broth mixture with a food material or materials in an amount of 0.01 to 50 times by weight of the resulting koji to form a koji, culture broth mixture, and food material mixture,
forming an unrefined soy by making the paste form of the koji, culture broth mixture, and food material mixture, and
hydrolyzing the unrefined soy substantially in the absence of sodium chloride.

2. The method according to claim 1, wherein said sterilized air is supplied continuously.

3. The method according to claim 1, wherein said sterilized air is supplied intermittently.

4. The method according to claim 1, wherein said food material is at least one food product selected from the group consisting of soybean, rice or wheat.

5. The method according to claim 1, wherein said koji mold is at least one bacterium selected from the group consisting of A. sojae and A. oryzae.

6. The method according to claim 1, wherein said bacteriocin producing lactic acid bacterium is a nisin producing lactic acid bacterium.

7. The method according to claim 6, wherein the nisin activity of the culture broth of the nisin producing lactic acid bacterium or a supernatant thereof is 20 IU/ml or higher.

8. The method according to claim 6, wherein the nisin activity of the culture broth of the nisin producing lactic acid bacterium or a supernatant thereof is 200 IU/ml or higher.

9. The method according to claim 1, wherein the said lactic acid bacterium is Lactococcus lactis AJ110212 (FERM BP-8552).

10. The method according to claim 1, wherein the said sterilized air is sterilized with a filter that collects 99.97% or more of dust of 0.3 μm or larger.

11. The method according to claim 1, wherein the time period of koji making is 17 to 62 hours.

12. The method according to claim 1, wherein the time period of koji making in which the outside air is excluded is 15.5 to 61.5 hours.

13. The method according to claim 1, wherein the amount of the said culture broth of a bacteriocin producing lactic acid bacterium or a supernatant thereof added to the food material is 0.0001 to 0.2 times in weight of the food material.

14. The method according to claim 1, wherein the amount of the said culture broth of a bacteriocin producing lactic acid bacterium or a supernatant thereof added to the food material is 0.001 to 0.1 times in weight of the food material.

15. The method according to claim 1, wherein the amount of the said culture broth of a bacteriocin producing lactic acid bacterium or a supernatant thereof mixed with the resulting koji is 0.01 to 5 times in weight of the resulting koji.

16. The method according to claim 1, wherein said hydrolyzing is at a temperature ranging from 20 to 50° C. for 1 to 50 days.

17. The method according to claim 1, wherein said hydrolyzing is at a temperature ranging from 20 to 45° C. for 3 to 30 days.

18. The method according to claim 1, wherein said “TEIRE”-treatment is for a time of less than 1.5 hours and at a frequency of once every 5-15 hours during koji making.

19. The method according to claim 1, wherein said “TEIRE”-treatment is for a time of less than 30 minutes and at a frequency of once every 10 hours during koji making.

20. A fermented soybean paste-like foodstuff obtained by the method according to claim 1.
